(19) United States
(12) Patent Application Publication
(10) Pub. No.: US 2017/0200118 A1
(43) Pub. Date: Jul. 13, 2017

(54) SYSTEMS AND METHODS OF MAPPING STORAGE FACILITIES

(71) Applicant: Wal-Mart Stores, Inc., Bentonville, AR (US)

(72) Inventors: Erica C. Jones, Bentonville, AR (US); Andrew J. Rizkallah, Bentonville, AR (US)

(21) Appl. No.: 15/399,191

(22) Filed: Jan. 5, 2017

Related U.S. Application Data
(60) Provisional application No. 62/275,881, filed on Jan. 7, 2016.

(51) Int. Cl. G06Q 10/08; G06F 17/24

(52) U.S. Cl. CPC G06Q 10/087; G06F 17/246

(57) ABSTRACT

In some embodiments, systems and methods are provided herein useful to map storage facilities. Some embodiments a display device; a computer readable memory; and a control circuit to: cause the display device to display a spreadsheet user interface; receive a sectional spreadsheet comprising: a reference location for a section of the storage facility, dimension information for each of a plurality of storage spaces distributed along the section, and a plurality of storage space identifiers specified in different cells of the sectional spreadsheet; determine three dimensional coordinates for each of the plurality of storage spaces based on a cell location of each of the plurality of storage space identifiers, the reference location, and the dimension information; and associate the three dimensional coordinates of each of the plurality of storage spaces with the storage space identifier of each of the plurality of storage spaces in the computer readable memory.

### CROSS-REFERENCE TO RELATED APPLICATION

This application claims the benefit of U.S. Provisional Application No. 62/275,881, filed Jan. 7, 2016, which is incorporated herein by reference in its entirety.

### TECHNICAL FIELD

This invention relates generally to mapping storage facilities.

### BACKGROUND

In a modern retail environment, large numbers of products are distributed throughout a region or country. These products are typically transported from a manufacturer or shipping location to one or more storage facility, and are redistributed to retail stores or other such outlets. As such, the storage of products is often critical to shopping facilities. Further, the ability to distribute products as needed is important to maintain desired product levels.

### BRIEF DESCRIPTION OF THE DRAWINGS

Disclosed herein are embodiments of systems, apparatuses and methods pertaining mapping of product storage facilities. This description includes drawings, wherein:

FIG. 1 illustrates a simplified block view of an exemplary storage facility mapping system, in accordance with some embodiments.

FIG. 2 illustrates a simplified block diagram of an overhead view of exemplary sections of a portion of a storage facility.

FIG. 3 illustrates an example of a portion of a sectional spreadsheet in accordance with some embodiments.

FIG. 4 illustrates an example of a portion of a sectional spreadsheet in accordance with some embodiments.

FIG. 5 illustrates a simplified flow diagram of an exemplary process of mapping a storage facility, in accordance with some embodiments.

FIG. 6 illustrates a simplified flow diagram of an exemplary process of mapping a storage facility, in accordance with some embodiments.

FIG. 7 illustrates an exemplary system for use in implementing systems, apparatuses, devices, methods, techniques and the like in monitoring the unloading and/or loading of a delivery of products in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are described herein to map one or more storage facilities having a plurality of stacked storage spaces or volumes that are distributed throughout the storage facility and configured to receive and temporarily store products. Further, the some embodiments enable the populating of spreadsheets corresponding to sections within a storage facility (e.g., distribution center, warehouse, shopping facility and the like), and converting the data of the populated spreadsheets into coordinate data used in mapping the storage facility. Some embodiments include a display device, computer readable memory; and one or more control circuits coupled to the display device and the computer readable memory. The control circuit can cause the display device to display a spreadsheet user interface. Typically, a plurality sectional spreadsheets and/or spreadsheet data populating the sectional spreadsheets is received through the spreadsheet user interface. Each of the sectional spreadsheets corresponds to a geographic area or section of the storage facility. In some embodiments, one or more of the sectional spreadsheets include a reference location for a section of the storage facility with which the sectional spreadsheet corresponds, dimension information for a plurality of storage spaces in the section, and a plurality of storage space identifiers each in a cell of the sectional spreadsheet. Three dimensional coordinates are determined for each of the plurality of storage spaces based on a cell location of each of the plurality of storage space identifiers, the reference location, and the dimension information for the plurality of storage spaces. The three dimensional coordinates of each of the plurality of storage spaces are associated with the storage space identifier of each of the plurality of storage spaces in the computer readable memory.

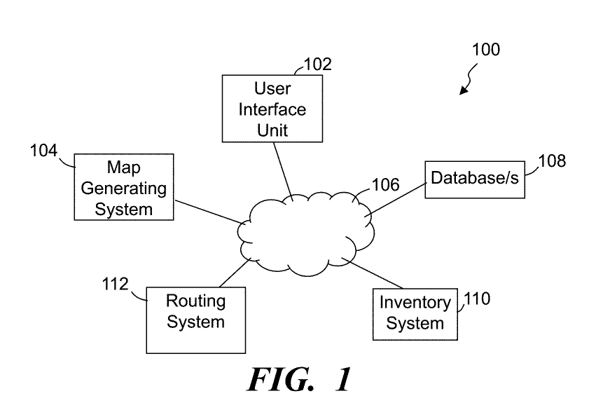

FIG. 1 illustrates a simplified block view of an exemplary storage facility mapping system 100, in accordance with some embodiments. The mapping system includes one or more user interface units 102 and a map generating system 104 that are communicatively coupled over one or more wired and/or wireless networks 106 (e.g., LAN, WAN, Wi-Fi, Bluetooth, Internet, other such networks, or combination of two or more of such networks). One or more databases 108 are typically further included that include computer and/or processor readable memory to store relevant information utilized by one or more of the components of the mapping system.

The mapping system 100, in some applications, may additionally include an inventory system 110 that receives and maintains inventory information corresponding to the storage facility. The inventory information can include product identifier information of products temporarily stored at the storage facility, product location information defining locations within the storage facility where products a temporarily placed, quantity information, pricing information, delivery and/or distribution information, and other such information relevant to tracking inventory coming into, stored at and being distributed from the storage facility.

The one or more databases 108 may store dimension information, storage facility mapping, storage facility dimension information, rack and/or shelf dimensions information, rack and/or shelf location information, rack and/or shelf configuration information, product location information, product information, spreadsheet data, other such information, and typically a combination of two or more of such information. Further, the databases may be distributed at multiple different locations and communicatively coupled with one or more components of the mapping system. Similarly, some or all of the data stored in the databases may be duplicated one or more times and distributed over the one or more networks 106.

Although the mapping system 100 is described above and further below with reference to a single storage facility, those skilled in the art will appreciate that the mapping system 100 can extend to multiple storage facilities and provide at least mapping for the multiple storage facilities. The storage facility can be a distribution center, warehouse, retail store, or other such storage facility where products are delivered and temporarily stored before being distributed and/or sold.

The mapping system 100, in part, provides a simplified process of entering information that defines the relative locations of storage spaces within the storage facility and accompanying dimensions or size of the storage spaces. This storage space information can then be used in generating a three-dimensional (3D) mapping of at least the storage spaces within the storage facility. The storage facility typically includes a series of sections (e.g., aisles, walkways, area, etc.) along which one or more storage spaces are arranges. For example, a storage facility may include a grid of multiple sections, and storage spaces are defined along one or both sides of the sections. Typically multiple storage spaces are stacked vertically and horizontally along at least one side, and often along both sides of the sections.

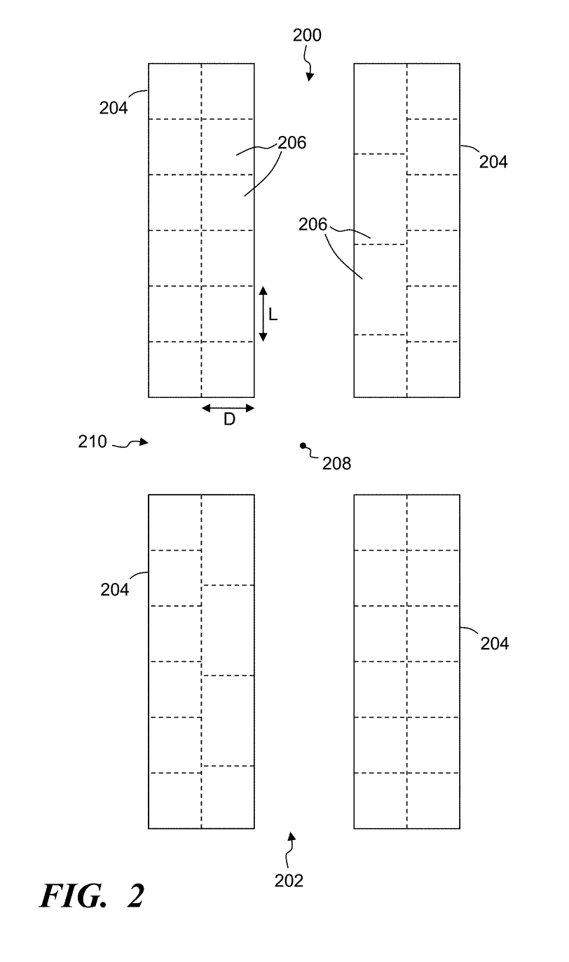

FIG. 2 illustrates a simplified block diagram of an overhead view of exemplary sections 200, 202 of a portion of a storage facility, in accordance with some embodiments. Each section includes one or more racks or racking systems 204, and in most instances each section includes a rack 204 on each side of the section. Formed within the racks are the storage spaces 206 that are arranged along the length of the section 200, 202. The storage spaces each have a length L, height, and depth D. Further, the storages spaces can vary in length, height and/or depth, and in some instances may vary in length, height and/or depth along a column and/or row of a rack. The storage spaces are typically configured to receive products to be temporarily be stored. For example, the storage space may be configured to receive a pallet of products with a predefined width, height and depth. In some embodiments, the sections 200, 202 include a plurality of shelves with a plurality of the plurality of storage spaces comprises the plurality of shelves each having a plurality of vertically stacked storage spaces. Similarly, the sections can include a plurality of vertically and/or horizontally stacked shelves each having one or more of the storage spaces extending along a length of each shelf

Referring back to FIG. 1, the one or more user interface units 102 are configured to be transported (e.g., carried, pushed on wheels, etc.) by a user/worker as the worker travels along one or more sections 200, 202 of the storage facility. The user interface unit can be substantially any relevant device that can be transported by the user and display spreadsheet user interfaces to the user and allow the user to enter relevant data through the spreadsheet user interfaces. For example, the user interface unit can be a smart phone, portable computer, laptop, tablet, optical-head mounted display system, smart watch system, product scanning system, storage facility specific wireless communication devices, and other such electronic user devices.

Utilizing the user interface units to access one or more of the available spreadsheet user interfaces, the user can enter storage space parameter information that is subsequently utilized in mapping at least the storage spaces in the storage facility. The user interface unit displays, through a display device of the user interface, a spreadsheet user interface. The spreadsheet user interface provides one or more spreadsheets that include cells that provide identifier information and/or allow the user to enter information consistent with the cell. As such, the user can interact with the spreadsheet user interface to enter data through a user interface.

In some embodiments, the user interface unit receives, through the spreadsheet user interface, one or more sectional spreadsheets. Typically, a sectional spreadsheet corresponds to one of the sections 200, 202 of the storage facility, and in some instances, a sectional spreadsheet is defined for each section of the storage facility that is being mapped. In some implementations, the sectional spreadsheet includes a reference location for the section of the storage facility with which the sectional spreadsheet corresponds. The reference location 208 corresponds to a location within the storage facility that is used as a reference from which storage space location information is defined, and/or dimension information is defined. The reference location can correspond to a corner of one of the racks 204, a center location between two corners of two racks 204 on opposite sides of a section 200, a central location between aligned sections (e.g., section 200 and section 202), and a cross section 210 that separates two aligned sections, or other such location that can be used as a reference location from which other locations, dimensions, distances, and/or directions can be defined.

The sectional spreadsheet is further configured to receive, as entered by the user through the user interface, dimension information for each of a plurality of storage spaces 206 in the section corresponding to the sectional spreadsheet, and a plurality of storage space identifiers corresponding to the storage spaces 206 in the section. Typically, each of the reference location, the dimension information for each of the plurality of storage spaces distributed along the section, and the plurality of storage space identifiers are each specified in a different cell of the sectional spreadsheet intended for that corresponding information. In some embodiments, for example, the sectional spreadsheet is organized such that an increasing row value of a cell containing a storage space identifier corresponds to an increasing distance from the reference location. Accordingly, the sectional spreadsheet organizes the cells to correspond to the intended information that can subsequently be used in generating a mapping of the storage facility.

Using this information in the sectional spreadsheet, the three dimensional coordinates for each of the plurality of storage spaces 206 along the section 200, 202 can be determined based on a cell location in the sectional spreadsheet of each of the plurality of storage space identifiers, the corresponding reference location, and the corresponding dimension information for the plurality of storage spaces. The determined three dimensional coordinates of each of the plurality of storage spaces are associated with the storage space identifier of each of the plurality of storage spaces in the computer readable memory.

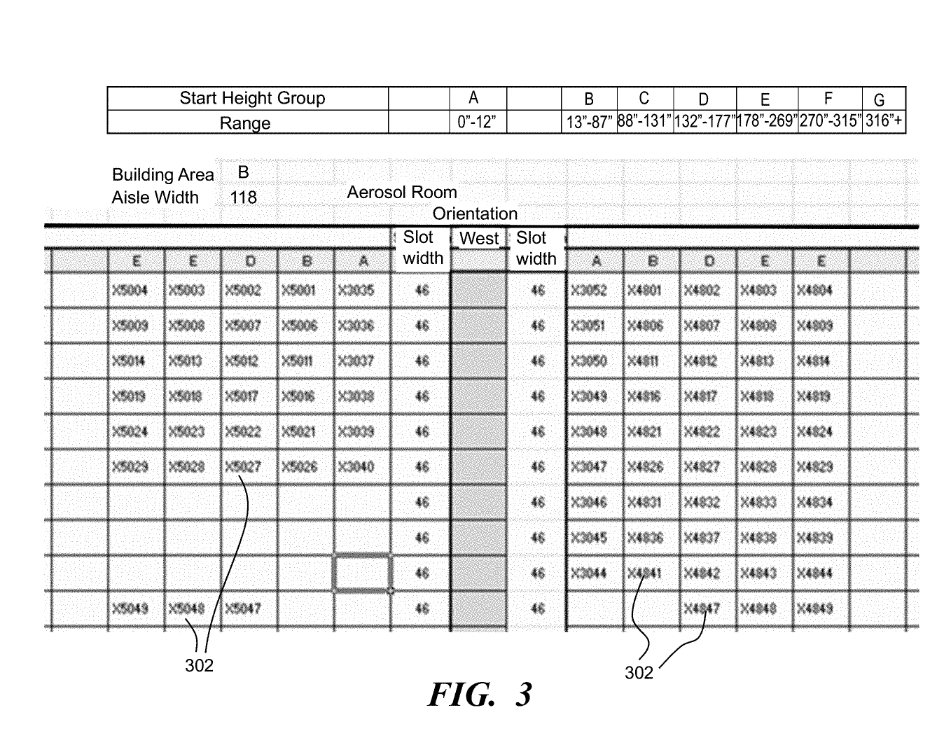

Accordingly, the sectional spreadsheet defines dimensions of storage spaces distributed along one or both sides of a storage space, and are organized relative to the designated reference location. FIG. 3 illustrates an example of a portion of a sectional spreadsheet in accordance with some embodiments. In some instances, cells in the sectional spreadsheet are organized such that storage space identifiers 302 corresponding to storage spaces that are physically horizontally adjacent along the section 200, 202 are specified in cells that are adjacent in a first direction, and storage space identifiers 302 corresponding to storage spaces that are physically vertically adjacent are specified in cells that are adjacent in a second direction.

Some embodiments define a separate sectional spreadsheet for each section 200, 202 of the storage facility, and the multiple sectional spreadsheets corresponding to a single storage facility are associated within a spreadsheet file. In some applications, a single spreadsheet database can include multiple separate sectional spreadsheets corresponding to the different sections of the storage facility. In displaying the spreadsheet file, the user interface may display a separate tab or other indicator that corresponds to each of the different sectional spreadsheets corresponding to the different sections of the storage facility.

In some embodiments, plurality of sectional spreadsheets, each corresponding to a section of the storage facility, are aggregated into a single file and/or database. Additionally or alternatively, the data from each of the plurality of sectional spreadsheets are aggregated. The aggregated sectional spreadsheets and/or data can be applied to form a three-dimensional (3D) mapping of the storage facility. In some applications, the organization of the sectional spreadsheets allows the aggregated sectional spreadsheets and/or data to be communicated to the map generating system 104 and/or a mapping application in a format that is needed by the mapping generating system and/or application. As such, the spreadsheet user interface provides a simplified interface to allow users to easily enter parameter information in a way that is conceptually consistent with the physical layout of the sections. Further, the data is easily parsed and reviewable through the spreadsheet user interface. The entered data can then be readily applied by the mapping application in generating the three dimensional map of the storage facility or at least those parts of the shopping facility for which data has been entered into the spreadsheet file and/or database. Again, in some implementations, each of the sectional spreadsheet can comprise and/or corresponds to a tab in a spreadsheet file.

As introduced above, one or more of the sectional spreadsheets can correspond to sections 200, 202 of the storage facility. In some instances, each of one or more of the sections corresponds to an aisle of the storage facility. The plurality of storage space identifiers entered into a sectional spreadsheet of an aisle corresponds to storage spaces on at least one side, and typically on two sides of the aisle. The sectional spreadsheet can further include an entry cell into which a user can enter pathway width information that defines a width of the aisle and/or the space separating two racks 204 on opposing sides of the aisle of the section for which sectional data is being entered into a sectional spreadsheet. The three dimensional coordinates for each of the plurality of storage spaces can then be further determined based on the pathway width information in addition a corresponding cell location of each of the plurality of storage space identifiers, the reference location, and the dimension information for the plurality of storage spaces. The sectional spreadsheet or a related spreadsheet may further include pathway or aisle identifier information. A user can provide the pathway identifier information by specify a name, alphanumeric code or other such naming convention to distinguish between pathways. Similarly, some embodiments may generate intersection naming of an intersection of two or more pathways and/or allow a user to specify intersection naming. Some embodiments may include a separate pathway or aisle spreadsheet that can include pathway identifier information, intersection information and the like. Similarly, some embodiments may include an intersections spreadsheet that includes pathway intersection identifier information, and other information (e.g., dimensions of pathways, reference location information, etc.).

The reference location for a section is used to determine orientation of the storage spaces, and in some applications is used to determine dimensions and/or sizes of storage spaces. In some embodiments, the cells within a sectional spreadsheet are arranged so that space identifiers in subsequent rows of the spreadsheet are further from the reference location. The mapping of the storage spaces uses the cell position within the spreadsheet and the dimensions of the storage spaces to calculate a location within the storage facility of the identified storage space from the reference location. In some implementations, the reference location defines a three-dimensional coordinate that corresponds to a center point of a cross section adjacent to the section of the storage facility associated with the sectional spreadsheet. In other instances, the reference location may be a midpoint between two corners of opposing racks 204, a corner of a rack, or other such reference location.

In some embodiments, the racks are often configured such that storage sections that are vertically aligned have the same width. As such, the sectional spreadsheet may be organized with sets cells along a single row corresponding to sets of vertically aligned storage spaces. An additional cell in that row can be associated with a set of cells along the single row and into which the worker can enter, through the spreadsheet user interface, the consistent width of that set of storage spaces. Similarly, the storage facility can be configured with storage spaces that have heights that are one of several predefined heights, and/or storage spaces can be associated with one of multiple different predefined height ranges (e.g., 0-12 inches; 13-87 inches, 88-131 inches, 132-177 inches, 178-269 inches, 270-315 inches, and greater than 316 inches). In some implementations, the sectional spreadsheet can be configured with each column of a set of columns corresponding to a predefined storage space height or a predefined height range, and the storage space identifiers can be incorporated into a cell in a column that corresponds with the height of the storage cell and/or into a column that corresponds with a height range. Vertically adjacent cells, in some instances, can further correspond to horizontally adjacent storage spaces along the storage area. Further, some embodiments provide at least some automation where a user can specify a set of storage spaces that have the same dimensions and the spreadsheet user interface applicant can automatically populate the sectional spreadsheet for each of the set of storage spaces. For example, the user may specify a range of storage spaces that are adjacent horizontally and/or vertically that have the same dimensions, and the spreadsheet user interface unit can auto-populate the corresponding cells in the sectional spreadsheet. Further, the sectional spreadsheet can associate cells through formulas, links and the like. Similarly, one or more formulas can be associated with one or more cells that are applied in converting the sectional spreadsheet information to the map generating system 104.

Typically, each sectional spreadsheet further includes orientation information corresponding to a directional orientation of the plurality of storage spaces in relation to the reference location. In some embodiments, the orientation information corresponds an orientation of cells containing the storage space identifiers. For example, cells that are associated with increased row values (or column values) correspond to storage spaces that are further from the reference location in a direction as designated by the orientation information. As such, the orientation information can define a physical mapping direction in which the map generating system uses to identify a three-dimensional location of a storage space within the mapping of the storage facility. Further, in some implementations, the sectional spreadsheet is further organized with cells corresponding to storage spaces on one side of a section being mapped grouped as a first grouping, and cells corresponding to storage spaces on the opposite side of the section (i.e., a rack) grouped as a second grouping. For example, the first and second grouping of cells may extend vertically along the sectional spreadsheet, with one or more columns of cells separating the first grouping and the second grouping. Further, based on the designated orientation, the first and second groupings can be configured to be consistent with a user's perspective as the user travels along the section being mapped (e.g., the first grouping of cells can be on a left side of the sectional spreadsheet when the corresponding physical storage spaces are on a user's left when facing in the direction of the specified orientation; and the second grouping of cells can be on a right side of the sectional spreadsheet when the corresponding physical storage spaces are on a user's right when facing in the direction of the specified orientation). This organization and/or orientation of the cells further enhances the usability and intuitive use of the sectional spreadsheets.

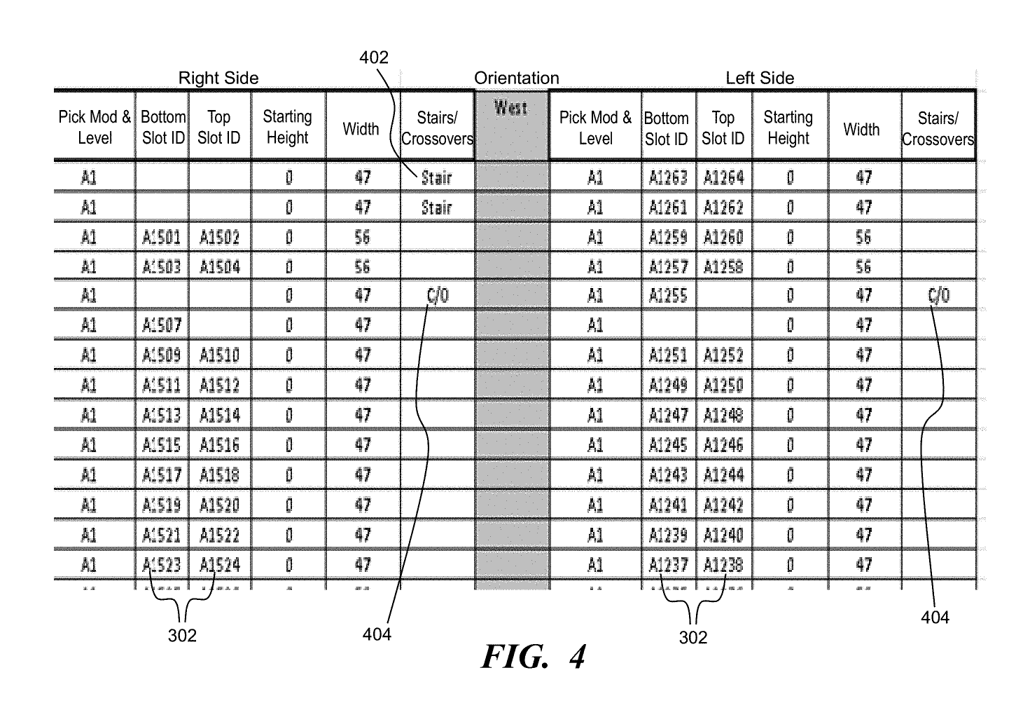

The storage facility typically has numerous sections. In some instances, the storage facility may have hundreds of sections. Those sections that store products usually include storage racks 204 with multiple storage spaces spaced along the length of the racks. In some instances, the racks include multiple vertically spaced shelves with storage spaces defined vertically relative to the vertically stacked shelves, and further storage spaces extending along the lengths of the racks. Some configurations provide storage spaces comprising or defined by a plurality of shelves each having a plurality of vertically stacked storage spaces. Further, some racks 204 include one or more sets of stairs, walkways, crossovers, bridges, and other such structural features that allow workers to reach different levels and areas of the racks to retrieve products stored at the different storage spaces. In some implementations, one or more conveyor belts may be cooperated with a rack and crossovers provide a walkway over the conveyor. As such, the sectional spreadsheets can further include information that define the dimensions of these structural features and/or their relative location along the section relative to the reference location. FIG. 4 illustrates an example of a portion of a sectional spreadsheet in accordance with some embodiments. Sets of cells can correspond to storage space identifiers 302, one or more cells 402 can designate stairs, one or more cells 404 can designate cross-overs (C/O), and/or other cells can correspond to other structural features. In this example, the racks being defined may be a two level rack with walkways to allow workers to reach upper levels. Although this example shows each level with a single storage space (sometimes referred to as a slot), other implementations allow for each level to have one or more storage spaces.

Further, one or more of these structural features may be vertically aligned with one or more storage spaces but have dimensions that extend horizontally across multiple storage spaces. Accordingly, the sectional spreadsheet would provide neighboring cells into which the worker can enter identifiers that identify those neighboring cells and part of a single structural feature and/or the worker merely specifies those neighboring cells with a single identifier that corresponds to a particular structural feature (e.g., a stairs identifier, a crossover identifier, etc.). The map generating system again detects the identification of the structural features and their location relative to the reference location for the section, and the dimensions as specified within the sectional spreadsheet.

Each cell that is corresponds to a storage space of the storage facility is further associated with the reference location of the section of the storage facility being mapped and corresponding dimensions of at least height and width. Additionally, the location of the cell within the sectional spreadsheet relative to other cells in the sectional spreadsheet corresponds to a physical location of the corresponding storage space relative to other storage spaces of the section. The three dimensional coordinates for the plurality of storage spaces can be determined based on a cell location of each of the plurality of storage space identifiers, the reference location, and the dimension information for the plurality of storage spaces. Further, the three dimensional coordinates are determined based on a relationship of a location of a cell within the sectional spreadsheet relative to one or more other cells of the sectional spreadsheet.

In some embodiments, the three dimensional coordinates of each storage spaces of a section is used to form a three dimension map of the section of the storage facility. The map generating system can receive the dimensions information and/or receive the sectional spreadsheets and determine from the spreadsheets the dimensions. The dimension information is used in cooperation with other dimension information, including but not limited to dimensions of the storage facility, locations and/or dimensions of other features of the storage facility (e.g., doors, walls, pillars, ramps, offices, stairs, etc.), to generate the three dimensional map of the storage facility or at least sections of the storage facility that store products to be placed into and retrieved from storage spaces. The three dimensional map of at least the one or more sections can then be used in stocking and/or retrieving products. In some embodiments, the three dimensional map can be used by an automated stocking/retrieving system that determines and communicates precise navigation commands for navigating the storage facility by an worker, a worker driving a forklift or other such retrieval vehicle, with one or more automated motored devices that autonomously move through the storage facility to place or retrieve products, other such navigation, or combinations of such navigation. In some applications, the user interface unit and/or the sectional spreadsheet application applies code to the data of the sectional spreadsheets to format dimensional and/or relative location information into a different format that is used by the map generating system. Additionally or alternatively, the user interface unit and/or the sectional spreadsheet application generates the three dimensional information and performs one or more conversions to format the information into a format that is compatible with the map generating system.

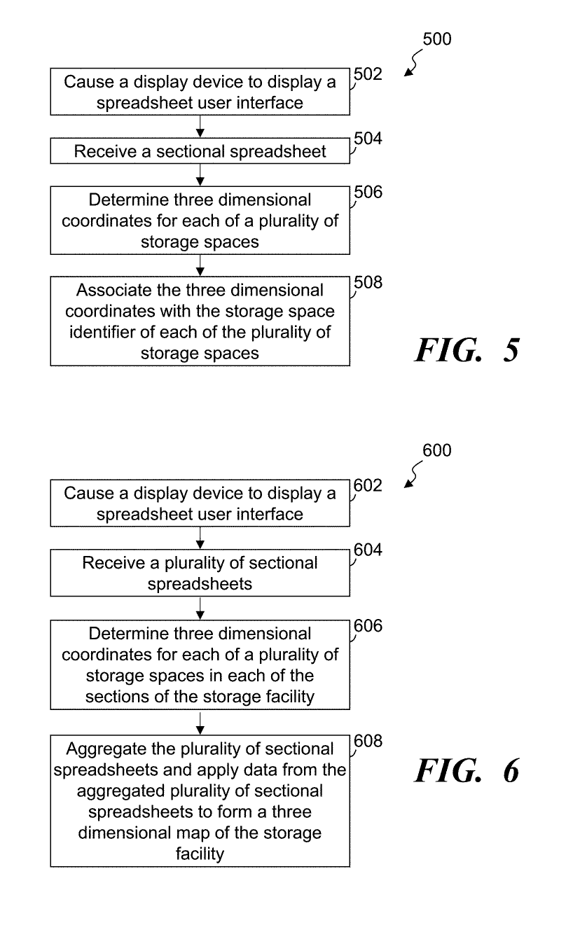

FIG. 5 illustrates a simplified flow diagram of an exemplary process 500 of mapping a storage facility, in accordance with some embodiments. In step 502 a display device is caused to display a spreadsheet user interface. Again, the spreadsheet user interface includes numerous cells that are to correspond to physical storage spaces within the storage facility being mapped. The spreadsheet user interface provides a simple and easy way to enter storage identifiers in a way that is consistent with the physical layout of a section of the storage facility. Further, the organization of the cells is intuitive to the user with the organization of the cells being sequential and consistent with the physical locations of storage spaces relative to each other along the section being mapped.

In step 504, a sectional spreadsheet is received through the spreadsheet user interface and/or information is received through the spreadsheet user interface populating the cells of the sectional spreadsheet. Again, the information received through the spreadsheet user interface can include, but is not limited to, a reference location for the one or more sections of the storage facility, dimension information for a plurality of storage spaces in the section, and a plurality of storage space identifiers each in a cell of the sectional spreadsheet. In step 506, three dimensional coordinates are determined, by the control circuit of the user interface unit and/or the map generating system, for each of the plurality of storage spaces based on a cell location of each of the plurality of storage space identifiers, the reference location, and the dimension information for the plurality of storage spaces. In step 508, the three dimensional coordinates of each of the plurality of storage spaces of the sectional spreadsheet are associated with the storage space identifier of each of the plurality of storage spaces in a computer readable memory.

Some embodiments further aggregate a plurality of sectional spreadsheets each corresponding to a different section of the storage facility apply data from the aggregated sectional spreadsheets in forming a three dimensional map of the storage facility. In some applications, a separate sectional spreadsheet is populated for each section of the storage facility that is being mapped. The one or more users, using the user interface units, each access the spreadsheet user interface and enter the relevant information consistent with the physical layout of each respective section. For example, the spreadsheet user interface displays the sectional spreadsheet that includes one or more cells to specify a section identifier, one or more reference locations 208, the orientation (e.g., compass designation, a designation relative to a facility reference location (e.g., a specified corner of the facility), or other such orientation information), storage space identifiers, and in some instances dimensions. In other instances, however, predefined storage space dimensions (e.g., a specific single dimension, a range, or other such dimension) are defined and the user enters the storage space identifier in one of the cells that corresponds to one of the predefined storage space dimensions consistent with the dimensions of the storage space being specified in the sectional spreadsheet. The collection of multiple sectional spreadsheets can then be collectively used to generate the mapping of at least portions of the storage facility. Typically, other spreadsheets are provided for other areas of the shopping facility that are not directly associated with a section of the shopping facility that stores products, such as but not limited to shipping bay sections, loading dock sections, product staging sections where products can be staged after unloading from or prior to loading onto delivery vehicles, and other such sections. Some embodiments maintain a single spreadsheet file with multiple tabs that correspond to the different sectional spreadsheets. As such, each of multiple sectional spreadsheets comprises and/or corresponds to a tab in a spreadsheet file.

In some embodiments, the sectional spreadsheet corresponds to an aisle of the storage facility and the plurality of storage space identifiers corresponds to storage spaces on two sides of the aisle. As such, some embodiments in receive, via the spreadsheet user interface, at least the storage space identifiers of a sectional spreadsheet receive the storage space identifiers of physical storage spaces of both sides of an aisle, such as storage spaces 206 in racks extending along both sides of an aisle. Some embodiments further receive pathway width information through the sectional spreadsheet, and/or other spreadsheet that defines spacing of sections and/or other portions of the storage facility. The sectional spreadsheet can further comprise the pathway width information, which in some instances defines a distance between racks 204 and/or a width of an aisle of the section corresponding to the sectional spreadsheet. In determining the three dimensional coordinates of each the storage spaces, some embodiments further determine the three dimensional coordinates of each the storage spaces based on the pathway width information. The plurality of storage spaces can comprise a plurality of shelves each having a plurality of vertically stacked storage spaces, and/or the plurality of storage spaces can comprise and/or be defined by a plurality of vertically stacked shelves each having a plurality of storage spaces extending along a length of each shelf such that the stacked shelves define an array of vertically and horizontally distributed storage spaces spaced along one or both sides of a pathway or aisle.

Some embodiments further receive, through the spreadsheet user interface displaying a sectional spreadsheet, the reference location 208 that can define a three-dimensional coordinate that corresponds to a center point of a cross section adjacent to the section of the storage facility associated with the sectional spreadsheet, a corner of one of the racks 204 of a section, or other location. In some instances, the sectional spreadsheet is organized with storage space identifier cells (in which a user enters storage space identifiers) that are closer to a top of this set of portion of the sectional correspond to storage spaces that are physically closer to the reference location, while storage space identifier cells that are further down the sectional spreadsheet intended for storage space identifiers that correspond to storage spaces that are further from the reference location. Some embodiments calculate the three dimensional coordinates using the reference location and the cell location within the sectional spreadsheets.

Some embodiments further receive through the spreadsheet user interface the orientation information specified by the user and/or determined based on a specified reference location. For example, the sectional spreadsheet may include one or more orientation cells into which the user specifies the orientation information such that the sectional spreadsheet will comprise the orientation information, which typically corresponds to a directional orientation of the plurality of storage spaces in relation to the reference location. Further, the sectional spreadsheet can be configured with an increasing row value of a cell containing a storage space identifier corresponding to an increasing distance from the reference location.

In some embodiments, the sectional spreadsheets are configured with at least storage space identifier cells organizes in a way that is consistent with the physical orientation of the storage spaces 206 along the section 200. For example, the sectional spreadsheet can be configured with storage space identifiers corresponding to storage spaces that are horizontally adjacent being received in cells adjacent in a first direction and storage space identifiers corresponding to storage spaces that are vertically adjacent being received in cells adjacent in a second direction. As such, in receiving the storage space identifiers through the spreadsheet user interface, some embodiments receive storage space identifiers corresponding to storage spaces that are physically horizontally adjacent in cells that are adjacent in a first direction and receive storage space identifiers corresponding to storage spaces that are physically vertically adjacent in cells that are adjacent in a second direction.

Again, the coordinate information defined in each of the sectional spreadsheets can provide and/or can be used to determine three dimensional coordinates relative to the reference location of the section 200, 202. In some applications the three dimensional coordinates of each of the plurality of storage spaces forms and/or is used in generating a three dimension map of the section of the storage facility. The map can be used by an automated stocking system for navigating the storage facility with one or more automated motored devices, a picker driving a fork lift to navigate the storage facility, or the like. For example, the routing system 112 can receive a product identifier for a product (or case, pallet, multiple pallets of a product) that are to be placed at or retrieved from a storage location. This information may be provided by the inventory system 110 based on defined storage spaces reserved for that product, a determination of a sufficient quantity of empty storage space, and/or other such information. The routing system 112 can use the mapping information, along with a known storage space location where the product is to be placed and/or from which the product is to be retrieved, in generating a defined route comprising one or more navigation commands through the storage facility from a location where the stocking system is located to the identified storage space(s). The navigation commands can then be followed by the stocking system to move to the identified storage space(s).

FIG. 6 illustrates a simplified flow diagram of an exemplary process 600 of mapping a storage facility, in accordance with some embodiments. In step 602, a display device is caused to display a spreadsheet user interface. In step 604, a plurality of sectional spreadsheets are received through the spreadsheet user interface. Each of the sectional spreadsheets correspond to a different section of the storage facility that each include a plurality of storage spaces. In some applications each of the plurality of sectional spreadsheets include a reference location, dimension information for a plurality of storage spaces, and a plurality of storage space identifiers each in a cell of the sectional spreadsheet. Typically, each of the reference location, dimension information for each of the plurality of storage spaces, and each of the plurality of storage space identifiers are entered into separate cells of the sectional spreadsheet.

In step 606, three dimensional coordinates are determined by a control circuit for each of the plurality of storage spaces in each of the sections of the storage facility for which sectional spreadsheets are populated. The three dimensional coordinates can be determined at least in part based on a cell location of each of the plurality of storage space identifiers in each sectional spreadsheet, the reference location for each section, and the dimension information for the plurality of storage spaces. In step 608, the plurality of sectional spreadsheets are aggregated and data from the aggregated plurality of sectional spreadsheets is applied to form a three dimensional map of the storage facility. The three dimensional mapping comprises three dimensional coordinates of each of the plurality of storage spaces in each of the plurality of sections.

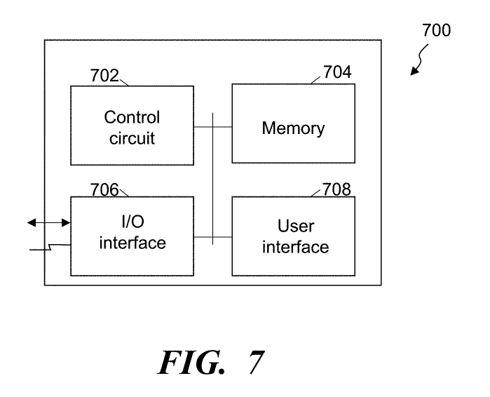

The methods, techniques, systems, devices, services, servers, sources and the like described herein may be utilized, implemented and/or run on many different types of devices and/or systems. Referring to FIG. 7, there is illustrated an exemplary system 700 that may be used for any such implementations, in accordance with some embodiments. One or more components of the system 700 may be used to implement any system, apparatus or device mentioned above or below, or parts of such systems, apparatuses or devices, such as for example any of the above or below mentioned user interface unit 102, map generating system 104, inventory system 110, routing system 112, and the like. However, the use of the system 700 or any portion thereof is certainly not required.

By way of example, the system 700 may include one or more system control circuits 702, memory 704, and input/output (I/O) interfaces and/or devices 706. Some embodiments further include one or more user interfaces 708. The system control circuit 702 typically comprises one or more processors and/or microprocessors. The memory 704 stores the operational code or set of instructions that is executed by the system control circuit 702 and/or processor to implement the functionality of displaying the sectional spreadsheets, receiving storage space identifiers and other relevant information (e.g., reference location, orientation information, dimension information, etc.), determining three dimensional coordinates, three dimensional mapping, generation of routing and/or navigation commands, tracking inventory, other such functionality, or a combination of two or more of such functionality. In some embodiments, the memory 704 may also store some or all of particular data that may be needed to receive storage facility parameter information (e.g., storage space identifiers, reference location information, dimensions information), product information, track product placement in one or more storage spaces, track location of one or more workers, forklifts, socking systems, etc., determine three dimensional information, and make any of the detections, associations, determinations, measurements and/or communications described herein. Such data may be pre-stored in the memory, received from an external source, be determined, and/or communicated to the system.

It is understood that the system control circuit 702 and/or processor may be implemented as one or more processor devices as are well known in the art. Similarly, the memory 704 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 704 is shown as internal to the system 700; however, the memory 704 can be internal, external or a combination of internal and external memory. Additionally, the system typically includes a power supply (not shown), which may be rechargeable, and/or it may receive power from an external source. While FIG. 7 illustrates the various components being coupled together via a bus, it is understood that the various components may actually be coupled to the system control circuit 702 and/or one or more other components directly.

Generally, the system control circuit 702 and/or electronic components of the system 700 can comprise fixed-purpose hard-wired platforms or can comprise a partially or wholly programmable platform. These architectural options are well known and understood in the art and require no further description here. The system and/or system control circuit 702 can be configured (for example, by using corresponding programming as will be well understood by those skilled in the art) to carry out one or more of the steps, actions, and/or functions described herein. In some implementations, the system control circuit 702 and the memory 704 may be integrated together, such as in a microcontroller, application specification integrated circuit, field programmable gate array or other such device, or may be separate devices coupled together.

The I/O interface 706 allows wired and/or wireless communication coupling of the system 700 to external components and/or or systems. Typically, the I/O interface 706 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 708 may be used for user input and/or output display. For example, the user interface 708 may include any known input devices, such one or more buttons, knobs, selectors, switches, keys, touch input surfaces, audio input, and/or displays, etc. Additionally, the user interface 708 includes one or more output display devices, such as lights, visual indicators, display screens, etc. to convey information to a user, such as but not limited to the sectional spreadsheets, the spreadsheet file, inventory information, storage space identifier information, product identifier information, dimensions, graphical interfaces, mapping, status information, notifications, errors, conditions, and/or other such information. Similarly, the user interface 708 in some embodiments may include audio systems that can receive audio commands or requests verbally issued by a user, and/or output audio content, alerts and the like.

Some embodiments further include and/or are in communication with one or more scanners, cameras, measurement sensors, orientation detectors, inertial sensors, and/or the like. For example, a scanner may be used by a user to scan a storage space identifier (e.g., a bar code, RFID, or the like placed at or adjacent to a storage location). As such, the user interface may allow the user to activate the scanner upon selecting a storage space identifier cell and/or a separate scanner option displayed on the user interface. The scanner can detect the storage space identifier and populate the selected storage space identifier cell and/or allow the user to move a display of the storage space identifier into a desired one or more of the storage space identifier cells. Additionally or alternatively, a keyboard or graphically displayed buttons may be displayed on the user interface (or a physical keyboard may be included on the user interface unit) that allows the user to enter the storage space identifier and/or modify an entered storage space identifier.

Some embodiments combine multiple sectional spreadsheets and/or other spreadsheets corresponding to other areas of the storage facility into coordinate data for the entire storage facility. The mapping is achieved, at least in part by causing a display device to display a spreadsheet user interface. A plurality of sectional spreadsheets are received and/or data populating the sectional spreadsheets is received through the spreadsheet user interface. Many of the sectional spreadsheets typically correspond to a different section of the storage facility having a plurality of storage spaces. Such sectional spreadsheets can include a reference location, dimension information for a plurality of storage spaces, and a plurality of storage space identifiers each in a cell of the sectional spreadsheet. For example, some of the sectional spreadsheets include multiple storage space identifier cells that are organized according to predefined dimensions or range of dimensions. Further, storage space identifier cells can be organized with cells adjacent corresponding to storage spaces that are physically adjacent, and with storage space identifier cells that are at a beginning of the set of storage space identifier cells in the sectional spreadsheet corresponding to storage spaces that are closer to the reference location 208 while storage space identifier cells that are closer to an end of the set of storage space identifier cells corresponding to storage spaces that are physically further from the reference location.

Some embodiments further determine three dimensional coordinates for each of the plurality of storage spaces in each of the sections based on a cell location of each of the plurality of storage space identifiers in each sectional spreadsheet, the reference location for each section, and the dimension information for the plurality of storage spaces. The plurality of sectional spreadsheets can be aggregated and data from the aggregated plurality of sectional spreadsheets applied to form a three dimensional map of the storage facility comprising three dimensional coordinates of each of the plurality of storage spaces in each of the plurality of sections.

Some embodiments provide the user with an option (e.g., in the spreadsheet application, defined in one or more cells of a sectional spreadsheet or other related spreadsheet, or the like) to clear existing data that may be in the spreadsheet. The clear option can cause a clearing of storage space identifier information, pathway or aisle area information (e.g., from an aisle area spreadsheet, which may be associated with an aisle tab in the spreadsheet file), open travel area data (e.g., dimensions, identifier information, etc.) from an open travel area (OTA) spreadsheet, intersection data (e.g., naming, dimensions, reference location, neighboring intersections, etc.) from an intersections spreadsheet, location type data from the location types spreadsheet, bay type data (e.g., type of loading bay, dimensions, intended use information, types of vehicles that can use the bay, etc.) from a bay types spreadsheet, storage facility identifier information (e.g., naming, size and/or dimensions, features, boundary coordinates, etc.) from a facility/warehouse spreadsheet, other such data, or combination of two or more of such data and/or spreadsheets. The open travel areas can define areas where workers, automated systems and/or retrieval devices (e.g., floor jacks, forklifts, etc.) can travel. Some embodiments are further configured to input data from one or more other spreadsheet files and/or spreadsheets. Similarly, some embodiments may input information from an external application and/or service, such as from the map generating system 104. An input option may be available through the spreadsheet user interface.

The spreadsheet interface simplifies the entry of data that can subsequently be used in a map generating system 104. The data is entered and recorded by a user. Further, the organization of the spreadsheet interface can be configured to correspond to a layout of the sections and provide form more inherent data entry. Scripts can be applied to the data to convert the data into one or more formats that are expected by a map generating system 104. In some implementations, the one or more interfaces can be provided to record mapping data that can be feed to the map generating system. The interfaces provide more user-friendly data entry than many map generating systems. Further, the interfaces can allow for various racking configurations to be mapped the same way. As such, the present embodiments are adaptable to various racking types and also the ease that a spreadsheet provides. In some instances, the one or more of the spreadsheet interfaces may be implemented through Microsoft Excel. One or more formulas can be defined, such as when storage spaces follow patterns to record their data into the sheets. In some applications, separate sectional spreadsheets are defined for each section of a storage facility. The interfaces allow for sections or aisles of any length, with various levels of storage spaces, varying dimensions of storage spaces, and other such customization. The user interfaces can accommodate various racking types, storage space naming, section naming, and easy incorporation of data. Templates can be created to simplify the recording of data out on the floor By being able to adapt to any storage facility configuration, the embodiments providing simplified ways to record information, automating the data importing process, and rapidly speeding up the mapping of storage facilities.

Some embodiments may further import data into one or more spreadsheets (e.g., sectional spreadsheet, aisle area spreadsheet, open travel area spreadsheet, intersections spreadsheet, location type spreadsheet, bay type data spreadsheet, facility/warehouse spreadsheet, etc.) from other spreadsheet files, other applications, or the like. For example, in some applications some data may be imported from the map generating system and/or data utilized by and formatted for the map generating system. In some instances, the imported data can be overwritten by a user accessing the one or more spreadsheets.

Typically, the spreadsheets and spreadsheet files are customizable for substantially any storage facility to be mapped. This can include customizing naming of storage spaces, sections, intersections, bay areas, and the like. For example, some implementations allows a user to specify a physical aisle the intersections name based on the physical aisle identifier, a logical aisle identifier, and in some instances a previous intersection identifier. Directional information may be specified, with alphanumerical characters used in naming. Additionally or alternatively, intersection naming may be defined based on portions of sections that cross. A numbers of characters to be used from one or more of the sections can be specified, and portions of the sections identifiers can be selected. In some embodiments, one or more of the datasheets specify a cardinal direction rather than a corresponding x or y direction. Because of that, the datasheets include and/or a user specifies where North is in correspondence to the way the map is to be generated. Some embodiments may additionally use the data from at least the sectional spreadsheets to generate AutoCAD mappings. These AutoCAD mappings may be generated before scripting and/or forwarding data to a separate map generating system to verify that formulas for aisles are building the aisle correctly. As such, some embodiments include an AutoCAD Script option that can draw, for example, one or more open travel areas, intersections, calculated aisles and levels, and the like.

In some embodiments, systems, apparatuses and methods are provided to support the mapping of a storage facility. Some embodiments include systems for mapping a storage facility comprising: a display device; a computer readable memory; and a control circuit coupled to the display device and the computer readable memory and configured to: cause the display device to display a spreadsheet user interface; receive, via the spreadsheet user interface, a sectional spreadsheet comprising: a reference location for a section of the storage facility, dimension information for each of a plurality of storage spaces distributed along the section, and a plurality of storage space identifiers, wherein the reference location, each of the dimension information, and each of the storage space identifiers are each specified in a different cell of the sectional spreadsheet; determine three dimensional coordinates for each of the plurality of storage spaces based on a cell location of each of the plurality of storage space identifiers, the reference location, and the dimension information for the plurality of storage spaces; and associate the three dimensional coordinates of each of the plurality of storage spaces with the storage space identifier of each of the plurality of storage spaces in the computer readable memory.

Further, some embodiments provide methods for mapping a storage facility comprising: causing a display device to display a spreadsheet user interface; receiving, via the spreadsheet user interface, a sectional spreadsheet comprising: a reference location for a section of the storage facility, dimension information for each of a plurality of storage spaces in the section, and a plurality of storage space identifiers each in a cell of the sectional spreadsheet; determining, by a control circuit, three dimensional coordinates for each of the plurality of storage spaces based on a cell location of each of the plurality of storage space identifiers, the reference location, and the dimension information for the plurality of storage spaces; and associating the three dimensional coordinates of each of the plurality of storage spaces with the storage space identifier of each of the plurality of storage spaces in a computer readable memory.

Some embodiments include methods for mapping a storage facility comprising: causing a display device to display a spreadsheet user interface; receiving, via the spreadsheet user interface, a plurality of sectional spreadsheets each corresponding to a different section of the storage facility having a plurality of storage spaces, each of the plurality of sectional spreadsheets comprising: a reference location, dimension information for a plurality of storage spaces, and a plurality of storage space identifiers each in a cell of the sectional spreadsheet; determining, by a control circuit, three dimensional coordinates for each of the plurality of storage spaces in each of the sections based on a cell location of each of the plurality of storage space identifiers in each sectional spreadsheet, the reference location for each section, and the dimension information for the plurality of storage spaces; and aggregating the plurality of sectional spreadsheets and applying data from the aggregated plurality of sectional spreadsheets to form a three dimensional map of the storage facility comprising three dimensional coordinates of each of the plurality of storage spaces in each of the plurality of sections.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for mapping a storage facility comprising:
a display device;
a computer readable memory; and
a control circuit coupled to the display device and the computer readable memory and configured to:
cause the display device to display a spreadsheet user interface;
receive, via the spreadsheet user interface, a sectional spreadsheet comprising: a reference location for a section of the storage facility, dimension information for each of a plurality of storage spaces distributed along the section, and a plurality of storage space identifiers, wherein the reference location, each of the dimension information, and each of the storage space identifiers are each specified in a different cell of the sectional spreadsheet;
determine three dimensional coordinates for each of the plurality of storage spaces based on a cell location of each of the plurality of storage space identifiers, the reference location, and the dimension information for the plurality of storage spaces; and
associate the three dimensional coordinates of each of the plurality of storage spaces with the storage space identifier of each of the plurality of storage spaces in the computer readable memory.

2. The system of claim 1, wherein the control circuit is further configured to aggregate the sectional spreadsheet and a plurality of other sectional spreadsheets each corresponding to a different section of the storage facility in forming a three dimensional map of the storage facility.

3. The system of claim 2, wherein the each of the sectional spreadsheet and the plurality of other sectional spreadsheets comprises a tab in a spreadsheet file.

4. The system of claim 1, wherein the sectional spreadsheet corresponds to an aisle of the storage facility and the plurality of storage space identifiers corresponds to storage spaces on two sides of the aisle.

5. The system of claim 1, wherein the sectional spreadsheet further comprises pathway width information and the three dimensional coordinates for each of the plurality of storage spaces are further determined based on the pathway width information.

6. The system of claim 1, wherein the reference location defines a three-dimensional coordinate that corresponds to a center point of a cross section adjacent to the section of the storage facility associated with the sectional spreadsheet.

7. The system of claim 1, wherein the sectional spreadsheet further comprises orientation information corresponding to a directional orientation of the plurality of storage spaces in relation to the reference location.

8. The system of claim 1, wherein in the sectional spreadsheet, an increasing row value of a cell containing a storage space identifier corresponds to an increasing distance from the reference location.

9. The system of claim 1, wherein the plurality of storage spaces comprise a plurality of shelves each having a plurality of vertically stacked storage spaces.

10. The system of claim 1, wherein in the sectional spreadsheet, storage space identifiers corresponding to storage spaces that are horizontally adjacent are in cells adjacent in a first direction and storage space identifiers corresponding to storage spaces that are vertically adjacent are in cells adjacent in a second direction.

11. The system of claim 1, wherein the three dimensional coordinates of each of the plurality of storage spaces forms a three dimension map of the section of the storage facility configured to be used by an automated stocking system for navigating the storage facility with one or more automated motored devices.

12. A method for mapping a storage facility comprising:
causing a display device to display a spreadsheet user interface;
receiving, via the spreadsheet user interface, a sectional spreadsheet comprising: a reference location for a section of the storage facility, dimension information for each of a plurality of storage spaces in the section, and a plurality of storage space identifiers each in a cell of the sectional spreadsheet;
determining, by a control circuit, three dimensional coordinates for each of the plurality of storage spaces based on a cell location of each of the plurality of storage space identifiers, the reference location, and the dimension information for the plurality of storage spaces; and
associating the three dimensional coordinates of each of the plurality of storage spaces with the storage space identifier of each of the plurality of storage spaces in a computer readable memory.

13. The method of claim 12, further comprising: aggregating the sectional spreadsheet and a plurality of other sectional spreadsheets each corresponding to a different section of the storage facility in forming a three dimensional map of the storage facility.

14. The method of claim 13, wherein the each of the sectional spreadsheet the plurality of other sectional spreadsheets comprises a tab in a spreadsheet file.

15. The method of claim 12, wherein the sectional spreadsheet corresponds to an aisle of the storage facility and the plurality of storage space identifiers corresponds to storage spaces on two sides of the aisle.

16. The method of claim 12, wherein the sectional spreadsheet further comprises pathway width information and the three dimensional coordinates for each of the plurality of storage spaces are further determined based on the pathway width information.

17. The method of claim 12, wherein the reference location defines a three-dimensional coordinate that corresponds to a center point of a cross section adjacent to the section of the storage facility associated with the sectional spreadsheet.

18. The method of claim 12, wherein the sectional spreadsheet further comprises orientation information corresponding to a directional orientation of the plurality of storage spaces in relation to the reference location.

19. The method of claim 12, wherein in the sectional spreadsheet, an increasing row value of a cell containing a storage space identifier corresponds to an increasing distance from the reference location.

20. The method of claim 12, wherein the plurality of storage spaces comprises a plurality of shelves each having a plurality of vertically stacked storage spaces.

21. The method of claim 12, wherein in the sectional spreadsheet, storage space identifiers corresponding to storage spaces that are horizontally adjacent are in cells adjacent in a first direction and storage space identifiers corresponding to storage spaces that are vertically adjacent are in cells adjacent in a second direction.

22. The method of claim 12, wherein the three dimensional coordinates of each of the plurality of storage spaces forms a three dimension map of the section of the storage facility configured to be used by an automated stocking system for navigating the storage facility with one or more automated motored devices.

23. A method for mapping a storage facility comprising:
causing a display device to display a spreadsheet user interface;
receiving, via the spreadsheet user interface, a plurality of sectional spreadsheets each corresponding to a different section of the storage facility having a plurality of storage spaces, each of the plurality of sectional spreadsheets comprising: a reference location, dimension information for a plurality of storage spaces, and a plurality of storage space identifiers each in a cell of the sectional spreadsheet;
determining, by a control circuit, three dimensional coordinates for each of the plurality of storage spaces in each of the sections based on a cell location of each of the plurality of storage space identifiers in each sectional spreadsheet, the reference location for each section, and the dimension information for the plurality of storage spaces; and
aggregating the plurality of sectional spreadsheets and applying data from the aggregated plurality of sectional spreadsheets to form a three dimensional map of the storage facility comprising three dimensional coordinates of each of the plurality of storage spaces in each of the plurality of sections.
